(19) United States
(12) Patent Application Publication
(10) Pub. No.: US 2015/0331686 A1
(43) Pub. Date: Nov. 19, 2015

(54) OVER-THE-AIR VEHICLE ISSUE RESOLUTION

(71) Applicant: Ford Global Technologies, LLC, Dearborn, MI (US)

(72) Inventors: Peter Eric PETERSEN, Royal Oak, MI (US); Cathleen TISTLE, Manchester, MI (US)

(73) Assignee: Ford Global Technologies, LLC, Dearborn, MI (US)

(21) Appl. No.: 14/278,853

(22) Filed: May 15, 2014

(51) Int. Cl. G06F 9/445

(52) U.S. Cl. CPC G06F 8/65

(57) ABSTRACT

A symptom database may associate vehicle parameters indicative of vehicle issues with software updates correcting the issues. A diagnostic server may receive vehicle parameters from a vehicle responsive to vehicle generation of a diagnostic code, utilize the symptom database to identify a software update corresponding to an issue indicated by the vehicle parameters, and provide a response identifying the software update for automatic installation by the vehicle to correct the issue. A processor of a vehicle may send, to a diagnostic server responsive to vehicle generation of a diagnostic code, vehicle parameters including the diagnostic code and an identifier of the vehicle, receive, from the diagnostic server, a response identifying a software update corresponding to an issue indicated by the vehicle parameters, receive the software update responsive to the response identifying the software update, and automatically install the software update.

### TECHNICAL FIELD

This disclosure generally relates to over-the-air vehicle issue resolution using vehicle-provided parameter information.

### BACKGROUND

Vehicles may include functionality to provide self-diagnostic information in the form of diagnostic codes. Diagnostic codes may be read from the vehicle, and used to allow one to identify operational status of various components or systems within the vehicle. For example, a driver of a vehicle with an illuminated check engine light may take the vehicle to a service center, where a mechanic may utilize special hardware to read and decode the diagnostic codes to identify and resolve any vehicle issue.

### SUMMARY

In a first illustrative embodiment, a system includes a symptom database associating vehicle parameters indicative of vehicle issues with software updates correcting the issues; and a diagnostic server configured to receive vehicle parameters from a vehicle responsive to vehicle generation of a diagnostic code, utilize the symptom database to identify a software update corresponding to an issue indicated by the vehicle parameters, and provide a response identifying the software update for automatic installation by the vehicle to correct the issue.

In a second illustrative embodiment, a system includes a processor of a vehicle configured to send, to a diagnostic server responsive to vehicle generation of a diagnostic code, vehicle parameters including the diagnostic code and an identifier of the vehicle, receive, from the diagnostic server, a response identifying a software update corresponding to an issue indicated by the vehicle parameters, receive the software update responsive to the response identifying the software update, and automatically install the software update.

In a third illustrative embodiment, a computer-implemented method includes receiving, responsive to vehicle generation of a diagnostic code, vehicle parameters including the diagnostic code and an identifier of the vehicle; utilizing a symptom database associating vehicle parameters indicative of vehicle issues with software updates correcting the issues to identify a software update corresponding to an issue indicated by the vehicle parameters; and providing the software updates to be automatically installed by the vehicle to correct the issue.

### BRIEF DESCRIPTION OF THE DRAWINGS

FIG. 1 is an exemplary block topology of a vehicle infotainment system implementing a user-interactive vehicle based computing system;

FIG. 2 illustrates an exemplary system for automatic identification of updates for a vehicle according to vehicle parameters;

FIG. 3 illustrates an exemplary data flow for automatic identification of software updates for a vehicle according to vehicle parameters;

FIG. 4 illustrates an exemplary process for automatically receiving software updates by a vehicle; and

FIG. 5 illustrates an exemplary process for automatically identifying software updates to address vehicle issues according to vehicle-provided vehicle parameters.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

A vehicle may be configured to send, during normal operation of a vehicle, parameters such as diagnostic codes (DTCs) to a diagnostic server. These parameters may be sent, for example, at key-on, while the vehicle is in motive mode, upon key-off, or, if the vehicle is so configured, when being plugged in for charging. The parameters may also include one or more elements of additional information, such as a unique identifier of the vehicle (e.g., vehicle identification number (VIN) information published on the controller area network (CAN) bus, subscriber identity module (SIM) information of an embedded vehicle modem such as international mobile station equipment identity (MEI)), an indication of the model of the vehicle, and/or information indicative of the current configuration and version information about the vehicle.

A vehicle may include various component modules configured to perform various tasks or subtasks for the vehicle. As some non-limiting examples, the vehicle modules may include a powertrain control module (PCM), a brake system control module (BSCM), and body control module (BCM). During operation of the vehicle, a vehicle module may raise a sequence of one or more diagnostic codes. This sequence of codes may be provided from the vehicle as parameters to the diagnostic server. In some cases, the vehicle driver may also be alerted of these codes, such as by way of a check engine light in the cabin of the vehicle.

The diagnostic server may be further configured to maintain a symptom database including associations of parameters indicative of a vehicle issues with software updates configured to address the corresponding issues. For example, the symptom database may have a record including an indication of a sequence of one or more diagnostic codes, and an association with an available software fix that may be installed to the vehicle to correct the issue causing the diagnostic codes. As new vehicle issues are identified, symptoms and indications of available software updates may be uploaded to the symptom database. In some cases, the software update may include updated configuration settings for one or more vehicle modules, while in other cases the software update may include a new version of software or firmware to be installed on one or more vehicle modules. In some examples, rather than maintaining the updates within the symptom database, the symptom database may include identifiers corresponding to the software updates that are stored in another location, such as within a software update data store.

As used throughout this disclosure, software and software updates may include data representing instructions that may be executed by a microprocessor, controller, or computer, of the vehicle-based computing system. Alternatively, or in combination, software updates may include data representing calibration, configuration, or other data or parameters used to control the vehicle operation, which may include operation of various vehicle modules, components, or systems, such as a vehicle infotainment system, on-board diagnostics (OBD) system, and similar systems.

Based on the symptom database, the diagnostic server may be configured to analyze the received vehicle parameters to identify potential issues with the vehicle. For instance, when the vehicle sends its vehicle parameters to the diagnostic server, the uploaded parameters may be checked by the diagnostic server against a symptom database. If the diagnostic server identifies based on the vehicle parameters that an available software update would resolve the issue, the diagnostic server may inform the vehicle to download and install the corresponding software updates from the software update data store. Responsive to the request, the vehicle may be configured to download and install the new software (e.g., at key-off, upon a “plugged-in” condition being experienced by a hybrid of electric vehicle, when the update information is received, etc.), without the need for customer interaction.

Thus, by using the system, vehicle issues may be automatically diagnosed and addressed, without requiring a customer to travel to a service center and have diagnostic codes pulled to determine which module was associated with a particular issue.

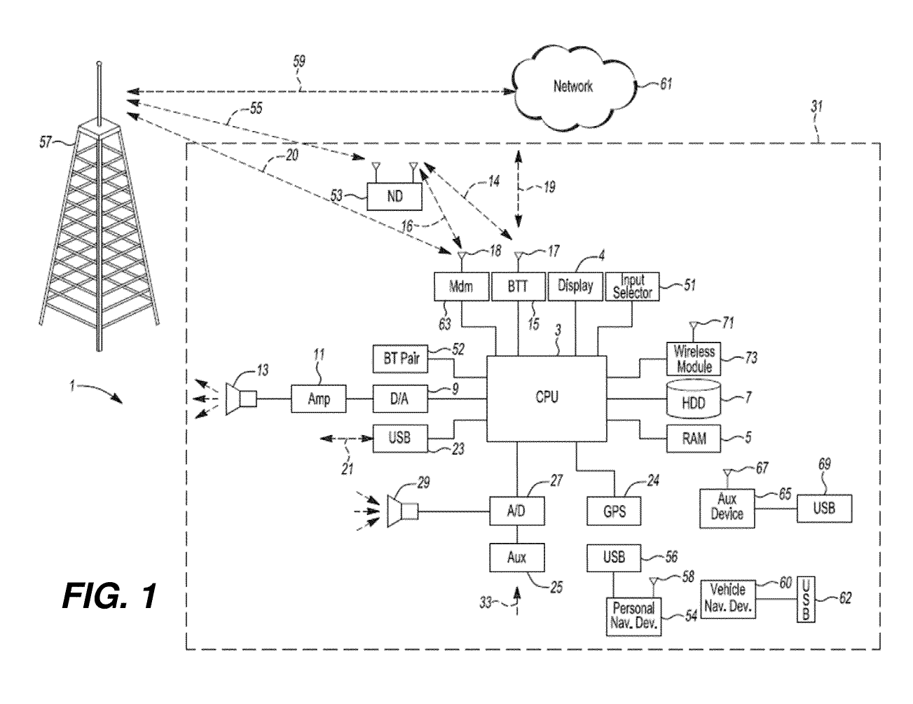

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touchscreen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

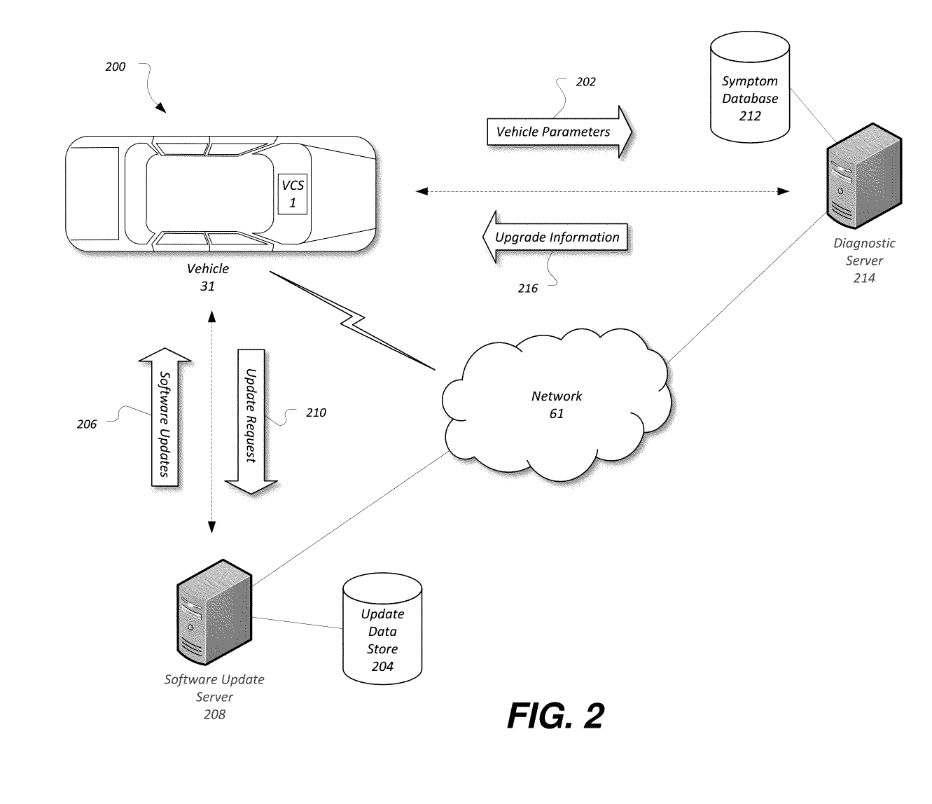

FIG. 2 illustrates an exemplary system 200 for automatic identification of software updates 206 for a vehicle 31 according to vehicle parameters 202. The system 200 includes a plurality of vehicles 31 configured to provide vehicle parameters 202 over the communications network 61. The system 200 may further include a diagnostic server 214 configured to maintain a symptom database 212, and use the symptom database 212 to identify and notify the vehicles 31 of upgrade information 216 according to the received vehicle parameters 202. The system 200 may also include a software update server 208 configured to maintain an update data store 204, and use the update data store 204 to provide software updates 206 to the vehicle 31 responsive to vehicle 31 update request 210. The system 200 may take many different forms and include multiple and/or alternate components and facilities. While an exemplary system 200 is shown in FIG. 2, the exemplary components illustrated in the Figure are not intended to be limiting. Indeed, the system 200 may have more or fewer components, and additional or alternative components and/or implementations may be used. As an example, while the symptom database 212 and update data store 204 are shown in the system 200 as separate data stores, in other examples the symptom database 212 and update data store 204 may be combined into a single database. As another example, while the diagnostic server 214 and software update server 208 are shown in the system 200 as separate servers, they may be combined into a single server, or in other cases split among multiple servers to accomplish load leveling, colocation or other data storage techniques.

The vehicle parameters 202 may include information collected during operation of the vehicle 31. The information may include parameters such as diagnostic codes (sometimes referred to as DTCs) that are generated by the vehicle 31 upon occurrence of various conditions. The parameters may also include one or more elements of additional information, such as a unique identifier of the vehicle 31 (e.g., a VIN of the vehicle 31, unique identifiers associated with a modem 63 of the vehicle 31, etc.), an indication of the model of the vehicle, and/or information indicative of the current configuration and version information about the modules of the vehicle. In some cases, the vehicle parameters 202 may include a sequence of parameters indicative of an issue being experienced by a module, component or system of the vehicle 31.

The update data store 204 may be configured to store software updates 206 that may be provided to the vehicle 31. The software updates 206 may include, for example, updated configuration settings for one or more vehicle 31 modules, components or systems, and/or an updated version of software or firmware to be installed on one or more vehicle 31 modules, components or systems. In some cases, a software update 206 may further include information indicative of the compatibility of the software updates 206 to vehicle 31 model or configuration. For instance, an entry for the software update 206 may indicate that the software update 206 is compatible with a certain make and model of vehicle 31, or that it has a dependency on a version of another module, component, or system of the vehicle 31 being of a particular version or versions.

The software update server 208 may be configured to maintain the update data store 204. For example, the software update server 208 may be configured to receive additions or changes to the maintained software updates, such as those created by support staff or development groups to resolve an issue being encountered with vehicles 31 on the road. The software update server 208 may be further configured to receive update requests 210 from vehicles 31, query the update data store 204 for updates responsive to receipt of the update requests 210, and respond to the update requests 210 with the requested software updates 206.

The symptom database 212 may be configured to store an association of vehicle parameters 202 to indications of software updates 206 configured to address issues indicated by the vehicle parameters 202. For example, the association may include an indication of a sequence of one or more diagnostic codes in association with a software update 206 that addresses an issue causing the sequence of diagnostic codes. The association may further include additional information, such as indications of which vehicles 31 may be compatible with the software update 206 (e.g., vehicle 31 make, vehicle 31 model, supported vehicle 31 module, component, or system versions, etc.).

The diagnostic server 214 may be configured to maintain the symptom database 212. For example, the software update server 208 may be configured to receive additions or changes to the maintained vehicle parameter 202 associations, such as additional vehicle parameters 202 added to the symptom database 212 indicative of an issue that is addressed by a new software update 206 added to the update data store 204. The diagnostic server 214 may be further configured to maintain information about the current configurations of the vehicles 31, such as module, component, or system versions, vehicle 31 make and model, associated vehicle 31 region or market, or other information that may be useful with respect to diagnosing issues with the vehicles 31.

The diagnostic server 214 may be further configured to receive the vehicle parameters 202 from the vehicles 31 of the system 200. The vehicle 31 may be configured to send the vehicle parameters 202 to the diagnostic server 214 during one or more operational modes, for example, at key-on, while the vehicle is in motive mode, upon key-off, or, if the vehicle 31 is so configured, when being plugged in for charging. The diagnostic server 214 may be further configured to query the symptom database 212 for indications of updates that may be available via the software update server 208 to address any issues indicated by the received vehicle parameters 202, and provide update information 216 to the vehicles 31 indicative of one or more software updates 206 that the vehicle 31 should install to address the identified issue. The vehicle 31 may accordingly receive the update information 216, and provide update requests 210 to the software update server 208 to retrieve the indicated updates.

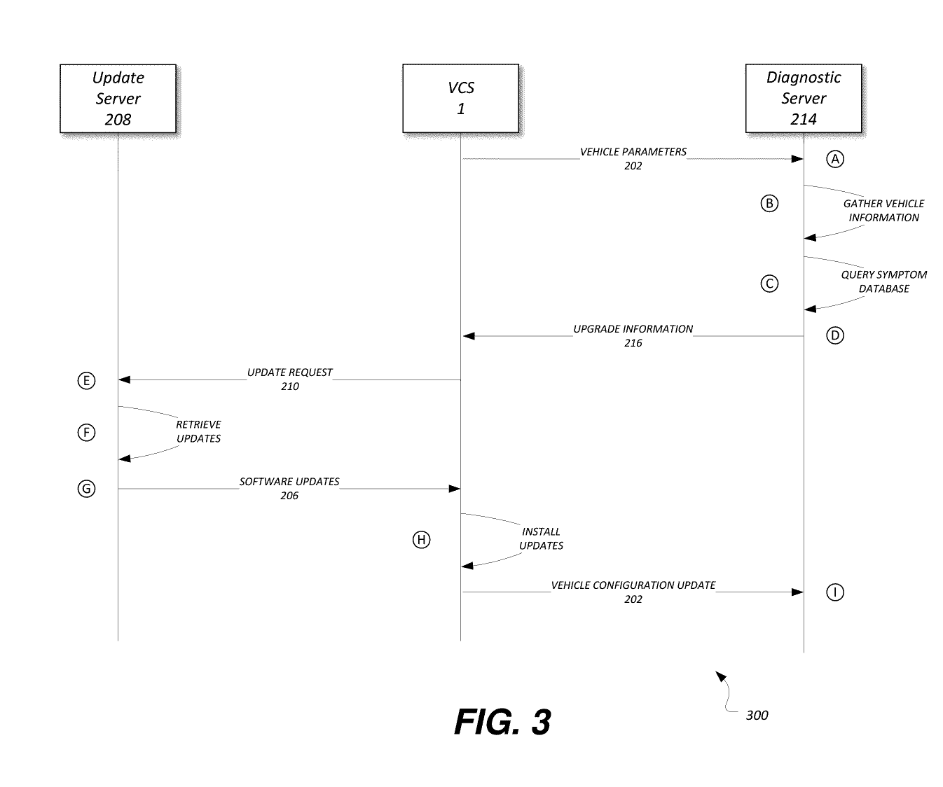

FIG. 3 illustrates an exemplary data flow 300 for automatic identification of software updates 206 for a vehicle 31 according to vehicle parameters 202. In the exemplary data flow 300, the vehicle 31 may receive and install software updates 206 to correct an issue identified by the diagnostic server 214 based on the vehicle parameters 202.

More specifically, at time index (A), the VCS 1 of the vehicle 31 sends vehicle parameters 202 over the network 61 to the diagnostic server 214. In some cases, the VCS 1 may provide the vehicle parameters 202 by utilizing an onboard modem 63 of the vehicle 31, while in other cases the VCS 1 may provide the vehicle parameters 202 using the data plan of the paired nomadic device 53 via the onboard BLUETOOTH transceiver 15. The vehicle parameters 202 may include information collected during operation of the vehicle 31, such as diagnostic codes that may have been stored, as well as vehicle-identifying information. The VCS 1 may be configured to provide the vehicle parameters 202 periodically, or upon detection of an event such as a diagnostic code being raised, or further responsive to another vehicle 31 event occurring after the triggering detection, such as key-on, key-off or plugging in.

At time index (B), the diagnostic server 214 gathers vehicle 31 information. For example, based on vehicle-identifying information included in the received vehicle parameters 202, the diagnostic server 214 may retrieve current configuration information maintained by or otherwise accessible to the diagnostic server 214 about the vehicle 31, such as current module, component, or system versions, make and model, and region or market. At time index (C), the diagnostic server 214 queries the symptom database 212. For example, the diagnostic server 214 may utilize the vehicle parameters 202 and other current vehicle configuration information to determine whether there are any software updates 206 available configured to address issues indicated by the vehicle parameters 202.

At time index (D), the diagnostic server 214 provides upgrade information 216 to the VCS 1 of the vehicle 31. For example, if the diagnostic server 214 determines, based on the symptom database 212, that software updates 206 are available to address an issue being experienced by the vehicle 31, the diagnostic server 214 may send upgrade information 216 to the vehicle 31 indicating the software updates 206 to be installed. In some cases, when a software module requires an update, the software update 206 may indicate dependencies on certain other modules being required to be at an updated version as well. Thus, the upgrade information 216 may further include indications of other software updates 206 that may be required to be performed as well to support the software update 206 addressing the identified issue.

At time index (E), the VCS 1 sends an update request 210 to the update server 208. For example, the VCS 1 may request the one or more software updates 206 from the update server 208. At time index (F), the update server 208 retrieves the requested software updates 206 from the update data store 204. Thus, the update server 208 may accordingly provide the requested software updates 206 back to the VCS 1. At time index (G), the VCS 1 receives the software updates 206 from the update server 208.

At time index (H), the VCS 1 applies the software updates 206 to the current vehicle 31 software installation. For example, the VCS 1 may determine from the software update 206 an intended module of the vehicle 31 to which the software update 206 is to be applied. As one possibility, the software update 206 may include a module address or other identifier configured to allow the VCS 1 to identify which module of the vehicle 31 should receive the software update 206, such that the VCS 1 may route the software update 206 to the proper module. To apply the update, the VCS 1 may be further configured to open a session with the destination module, provide the software update 206 to the module for installation, receive an indication of application of the update to the module, and close the session with the destination module. In an example, the VCS 1 may be configured to route the software update 206 to the appropriate module via the vehicle 31 controller area network (CAN) bus (e.g., using the module address or other identifier as intended destination of the software update 206). Thus, the VCS 1 may apply the updated configuration settings and/or updated software versions to address the identified issue. In some cases, the software updates may be installed at the next key-off after the software updates 206 are received.

At time index (I), the VCS 1 updates the diagnostic server 214 with the updated vehicle 31 configuration information. For example, upon successful installation of the software updates 206, the VCS 1 may provide updated vehicle information to the diagnostic server 214 to allow the diagnostic server 214 to check for further software updates 206 for the vehicle 31 using the current vehicle 31 configuration. In some cases, the updated vehicle 31 configuration information may be provided as further vehicle parameters 202 to the diagnostic server 214.

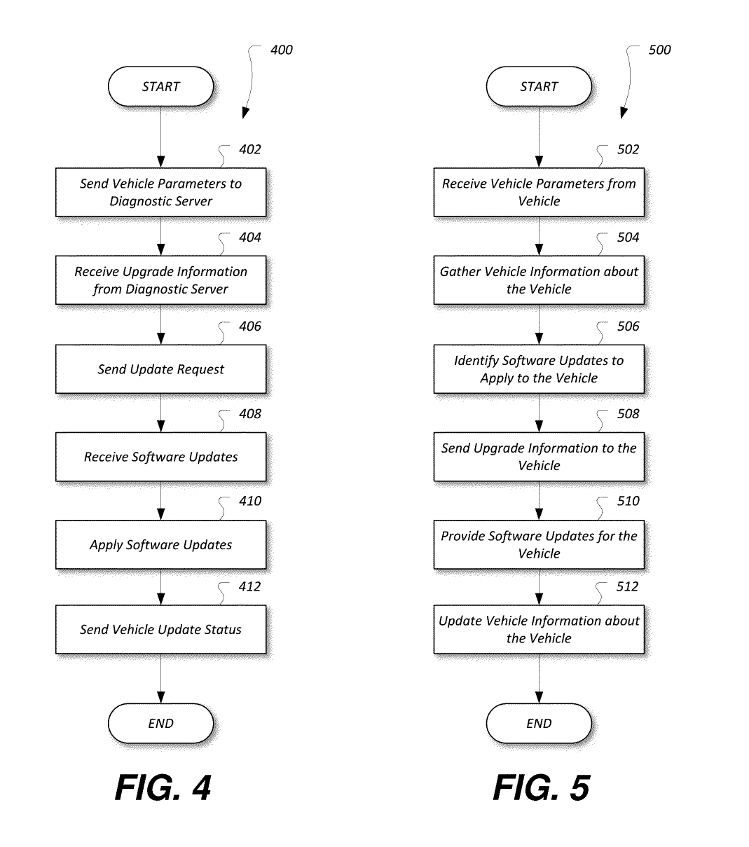

FIG. 4 illustrates an exemplary process 400 for automatically receiving software updates 206 by a vehicle 31. The process 400 may be performed, for example, by the VCS 1 in communication with the diagnostic server 214 and update server 208 over the network 61.

At operation 402, the VCS 1 sends vehicle parameters 202 to the diagnostic server 214. The vehicle parameters 202 may include information collected during operation of the vehicle 31, such as previously stored or currently triggered diagnostic codes, as well as vehicle-identifying information. At operation 404, the VCS 1 receives upgrade information 216 from the diagnostic server 214. For example, the VCS 1 may receive from the diagnostic server 214 upgrade information 216 indicating software updates 206 to be installed to address an issue being experienced by the vehicle 31 as identified from the vehicle parameters 202.

At operation 406, the VCS 1 sends an update request 210 to the update server 208. For example, the VCS 1 may request the one or more software updates 206 from the update server 208. At operation 408, the VCS 1 receives the requested software updates 206 from the update server 208, and at operation 410, the VCS 1 applies the requested software updates 206. Thus, the VCS 1 may apply the updated configuration settings and/or updated software versions to address the identified issue, responsive to receiving the upgrade information 216 from the diagnostic server 214. In some cases, the software updates may be installed at the next key-off after the software updates 206 are received.

At operation 412, the VCS 1 sends a vehicle update status to the diagnostic server 214. For example, upon successful installation of the software updates 206, the VCS 1 may provide updated vehicle information to the diagnostic server 214 as vehicle parameters 202, to allow the diagnostic server 214 to check for further software updates 206 for the vehicle 31 using the current vehicle 31 configuration. After operation 412, the process 400 ends.

FIG. 5 illustrates an exemplary process 500 for automatically identifying software updates 206 to address vehicle 31 issues according to vehicle-provided vehicle parameters 202. The process 500 may be performed, for example, by the diagnostic server 214 and update server 208 in communication with the VCS 1 over the network 61.

At operation 502, the diagnostic server 214 receives vehicle parameters 202 from the vehicle 31. For example, the diagnostic server 214 may receive vehicle parameters 202 sent from the VCS 1 periodically, or upon detection of an event such as a diagnostic code being raised, or upon another vehicle 31 event occurring, such as key-on, key-off, or the vehicle 31 being plugged-in for charging (e.g., as determined by an indicator of a vehicle 31 charging port, upon detection by the vehicle 31 charging system of incoming power flow, etc.). At operation 504, the diagnostic server 214 gathers vehicle information. For example, based on vehicle-identifying information included in the received vehicle parameters 202, the diagnostic server 214 may retrieve current configuration information maintained by or otherwise accessible to the diagnostic server 214 about the vehicle 31, such as current module versions, make and model, and region or market.

At operation 506, the diagnostic server 214 identifies software updates 206 for the vehicle 31. For example, the diagnostic server 214 may utilize the vehicle parameters 202 and other current vehicle 31 configuration information to query the symptom database 212 for indications of software updates 206 for the vehicle 31. At operation 508, the diagnostic server 214 sends upgrade information 216 to the vehicle 31. For example, the upgrade information 216 may include indications of the software updates 206 to be installed to the vehicle 31 to address an issue being experienced by the vehicle 31 as identified from the vehicle parameters 202.

At operation 510, the update server 208 provides the software updates 206 to the vehicle 31. For example, the update server 208 may receive an update request 210 from the VCS 1 requesting the software updates 206 indicated to the VCS 1 by the diagnostic server 214. The update server 208 may accordingly retrieve the requested software updates 206 from the update data store 204, and send the requested software updates 206 back to the VCS 1.

At operation 512, the diagnostic server 214 updates the vehicle information about the vehicle 31. For example, the diagnostic server 214 may receive updated vehicle information from the VCS 1 indicative of the updated vehicle 31 configuration. In some cases, the updated vehicle 31 configuration information may be provided to the diagnostic server 214 as vehicle parameters 202. After operation 512 the process 500 ends.

Thus, the diagnostic server 214 may utilize the symptom database 212 and received vehicle parameters 202 to identify vehicle 31 issues that are already resolved by an available software update 206, and instruct the vehicle 31 to install the software update 206 to resolve the issue, all without requiring the customer to travel to a service center and have codes pulled to determine which module was responsible for generation of the diagnostic code or code sequence.

As an example, a technician may determine that a threshold value set for a particular component temperature is set to a point that causes vehicles 31 to report temperature diagnostic codes that are not actually indicative of an abnormal vehicle 31 operating condition. The technician may accordingly create a software update 206 including updated configuration settings that modify the threshold value. This software update 206 may be added to the update data store 204. To allow vehicles 31 to automatically pick-up the update, the symptom database 212 may be updated to include an association of vehicle parameters 202 including the temperature diagnostic codes with an indication of the software update 206 modifying the threshold value. Thus, when a vehicle 31 reports the temperature diagnostic codes to the diagnostic server 214, the diagnostic server 214 may utilize the symptom database 212 to instruct the vehicle 31 to download and install the updated configuration settings software update 206 resolving the issue.

As another example, an engineer may determine that a battery charging algorithm for a plug-in hybrid vehicle 31 is producing certain vehicle parameter 202 diagnostic codes due to an issue in the charging algorithm. The engineer may accordingly design a software update 206 including a new charging function addressing the issue. This software update 206 may be added to the update data store 204. To allow vehicles 31 to automatically pick-up the update, the symptom database 212 may be updated to include an association of vehicle parameters 202 characteristic of the charging issue with an indication of the software update 206 including the new charging function. Thus, when a vehicle 31 reports vehicle parameters 202 characteristic of the charging issue, and is of the proper hybrid-vehicle type, the diagnostic server 214 may utilize the symptom database 212 to instruct the vehicle 31 to download and install the updated charging function software update 206.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a symptom database associating vehicle parameters indicative of vehicle issues with software updates correcting the issues; and
a diagnostic server configured to
receive vehicle parameters from a vehicle responsive to vehicle generation of a diagnostic code,
utilize the symptom database to identify a software update corresponding to an issue indicated by the vehicle parameters, and
provide a response identifying the software update for automatic installation by the vehicle to correct the issue.

2. The system of claim 1, wherein the software update includes at least one of an updated configuration setting to be applied to a vehicle module and an updated version of software to be applied to the vehicle module.

3. The system of claim 1, wherein the diagnostic server is further configured to identify the software update according to vehicle parameters including at least one of vehicle make, vehicle model, and vehicle hardware configuration.

4. The system of claim 1, wherein the diagnostic server is further configured to identify the software update according to vehicle parameters including a software version currently installed on a vehicle module.

5. The system of claim 1, wherein the diagnostic server is further configured to
receive from the vehicle an indication of a status of installation of the software update to the vehicle; and
responsive to the indication, update data indicative of a software version currently installed on a vehicle module.

6. The system of claim 1, wherein the vehicle parameters further include at least one of a unique identifier of the vehicle and a unique identifier of a network device providing access to a network over which the vehicle parameters are sent.

7. The system of claim 1, further comprising an update server configured to:
receive an upgrade request from the vehicle requesting the software updates; and
provide the software updates to the vehicle responsive to the request.

8. A system comprising:
a processor of a vehicle configured to
send, to a diagnostic server responsive to vehicle generation of a diagnostic code, vehicle parameters including the diagnostic code and an identifier of the vehicle,
receive, from the diagnostic server, a response identifying a software update corresponding to an issue indicated by the vehicle parameters,
receive the software update responsive to the response identifying the software update, and
automatically install the software update.

9. The system of claim 8, wherein the software update includes at least one of an updated configuration setting to be applied to a vehicle module and an updated version of software to be applied to the vehicle module.

10. The system of claim 8, wherein the processor of the vehicle is further configured to provide an indication of a status of installation of the software updates to the vehicle, the indication being indicative of a software version currently installed on a vehicle module.

11. The system of claim 10, wherein the processor of the vehicle is further configured to provide the indication of the status of installation as additional vehicle parameters.

12. The system of claim 8, wherein the processor of the vehicle is further configured to install the software update upon one of a key-off of the vehicle, a key-on of the vehicle, and plugging in of the vehicle for charging.

13. The system of claim 8, wherein the vehicle parameters further include at least one of a unique identifier of the vehicle and a unique identifier of a network device providing access to a network over which the vehicle parameters are sent.

14. A computer-implemented method comprising:
receiving, responsive to vehicle generation of a diagnostic code, vehicle parameters including the diagnostic code and an identifier of the vehicle;
utilizing a symptom database associating vehicle parameters indicative of vehicle issues with software updates correcting the issues to identify a software update corresponding to an issue indicated by the vehicle parameters; and
providing the software updates to be automatically installed by the vehicle to correct the issue.

15. The method of claim 14, wherein the software update includes at least one of an updated configuration setting to be applied to a vehicle module and an updated version of software to be applied to the vehicle module.

16. The method of claim 14, further comprising identifying the software update according to at least one of vehicle make, vehicle model, and vehicle hardware configuration.

17. The method of claim 14, further comprising identifying the software update according to a software version currently installed on a vehicle module.

18. The method of claim 14, further comprising:
receiving from the vehicle an indication of a status of installation of the software updates to the vehicle; and
responsive to the indication, updating data indicative of a software version currently installed on a vehicle module.

19. The method of claim 14, wherein the vehicle parameters further include at least one of a unique identifier of the vehicle and a unique identifier of a network device providing access to a network over which the vehicle parameters are sent.

20. The method of claim 14, further comprising:
receiving an upgrade request from the vehicle requesting the software updates; and
providing the software updates to the vehicle responsive to the request.
